(19) United States
(12) Patent Application Publication
(10) Pub. No.: US 2010/0191983 A1
(43) Pub. Date: Jul. 29, 2010

(54) SYSTEM AND METHOD FOR SECURE LOGGING OF DOCUMENT PROCESSING DEVICE MESSAGES

(76) Inventors: Sameer YAMI, Irvine, CA (US); Amir Shahindoust, Laguna Niguel, CA (US)

Correspondence Address: TUCKER ELLIS & WEST LLP, 1150 HUNTINGTON BUILDING, 925 EUCLID AVENUE, CLEVELAND, OH, 44115-1414, US

(21) Appl. No.: 12/360,483

(22) Filed: Jan. 27, 2009

(51) Int. Cl. G06F 12/14

(52) U.S. Cl. 713/193

(57) ABSTRACT

The subject application is directed to a system and method for secure logging of document processing device messages. A duration for capturing status messages is first defined and unencrypted document processing device status messages are received during the defined duration. An encryption key is generated for association with the duration and is thereafter associated with the duration. Each of the unencrypted document processing status messages is then encrypted using the key as it is received. The encrypted messages are then stored in an associated data storage. Following a completion of the defined duration, each of the encrypted messages is decrypted and then stored in a single, signed storage file. The signed storage file is then encrypted using the generated encryption key, and the encrypted storage file is associatively stored with the key.

### BACKGROUND OF THE INVENTION

The subject application is directed generally to secure storage of status messages from document processing devices. The application is particularly applicable to efficient and secure archiving of status messages over preselected durations, such as daily, to allow for ease in subsequent retrieval, avoiding issues such as lost or separated keys.

Document processing devices include copiers, printers, facsimile machines, electronic mail devices, scanners, and the like. More recently, two or more of functions are being placed in one device, referred to as a multifunction peripheral (MFP) or multifunction device (MFD). Multifunction peripherals are extremely powerful business tools. Power and flexibility of these devices come at a cost of complexity. Devices must be monitored and maintained by skilled personnel, such as administrators. To assist in such monitoring, many devices will periodically generate status messages. It is advantageous to store such messages to allow for subsequent tracing of device operation. However, in many environments, hundreds or thousands of messages can be generated in a short period of time. Additionally, many messages may include sensitive information, making it desirable to keep them from unauthorized viewing.

### SUMMARY OF THE INVENTION

In accordance with one embodiment of the subject application, there is provided a system and method for secure logging of document processing device messages. A message capture duration is defined and a plurality of unencrypted document processing status messages are received in accordance with a defined duration. An encryption key is generated for association with the defined duration and is associated with the defined duration. Each of the plurality of unencrypted document processing status messages is encrypted in accordance with the key as each message is received and stored in an associated data storage. The plurality of encrypted messages are then decrypted in accordance with the generated key following a completion of the defined duration. Each decrypted message is stored in a single, signed storage file, the signed storage file is encrypted in accordance with the key, and the encrypted storage file is associatively stored with the key.

Still other advantages, aspects and features of the subject application will become readily apparent to those skilled in the art from the following description wherein there is shown and described a preferred embodiment of the subject application, simply by way of illustration of one of the best modes best suited to carry out the subject application. As it will be realized, the subject application is capable of other different embodiments and its several details are capable of modifications in various obvious aspects all without departing from the scope of the subject application. Accordingly, the drawings and descriptions will be regarded as illustrative in nature and not as restrictive.

### BRIEF DESCRIPTION OF THE DRAWINGS

The subject application is described with reference to certain figures, including:

FIG. 1 is an overall diagram of a system for secure logging of document processing device messages according to one embodiment of the subject application;

FIG. 2 is a block diagram illustrating device hardware for use in the system for secure logging of document processing device messages according to one embodiment of the subject application;

FIG. 3 is a functional diagram illustrating the device for use in the system for secure logging of document processing device messages according to one embodiment of the subject application;

FIG. 4 is a block diagram illustrating controller hardware for use in the system for secure logging of document processing device messages according to one embodiment of the subject application;

FIG. 5 is a functional diagram illustrating the controller for use in the system for secure logging of document processing device messages according to one embodiment of the subject application;

FIG. 6 is a diagram illustrating an administrative workstation for use in the system for secure logging of document processing device messages according to one embodiment of the subject application;

FIG. 7 is a block diagram illustrating the system for secure logging of document processing device messages according to one embodiment of the subject application;

FIG. 8 is a functional diagram illustrating the system for secure logging of document processing device messages according to one embodiment of the subject application;

FIG. 9 is a flowchart illustrating a method for secure logging of document processing device messages according to one embodiment of the subject application; and

FIG. 10 is a flowchart illustrating a method for secure logging of document processing device messages according to one embodiment of the subject application.

### DETAILED DESCRIPTION OF THE PREFERRED EMBODIMENT

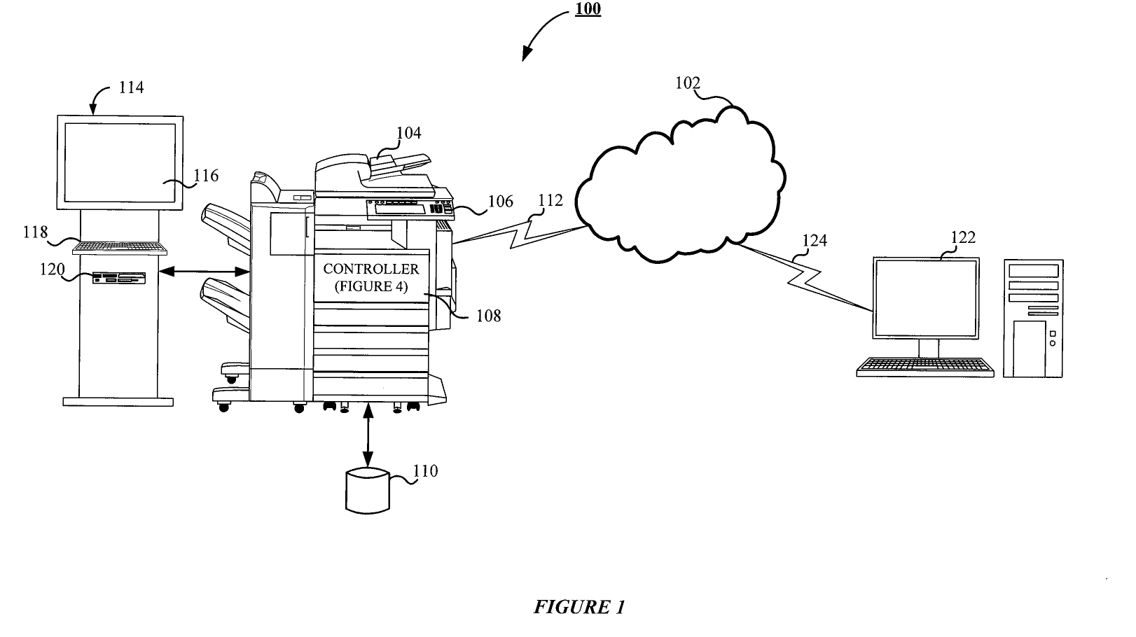

The subject application is directed to a system and method for secure storage of status messages of document processing devices. In particular, the subject application is directed to a system and method for secure archival of status messages collected over a preselected duration. More particularly, the subject application is directed to a system and method for securely storing logs generated during operations of a document processing device during a preselected period of time. It will become apparent to those skilled in the art that the system and method described herein are suitably adapted to a plurality of varying electronic fields employing secure logging, including, for example and without limitation, communications, general computing, data processing, document processing, financial transactions, vending of products or services, or the like. The preferred embodiment, as depicted in FIG. 1, illustrates a document processing field for example purposes only and is not a limitation of the subject application solely to such a field.

Referring now to FIG. 1, there is shown an overall diagram of a system 100 for secure logging of document processing device messages in accordance with one embodiment of the subject application. As shown in FIG. 1, the system 100 is capable of implementation using a distributed computing environment, illustrated as a computer network 102. It will be appreciated by those skilled in the art that the computer network 102 is any distributed communications system known in the art capable of enabling the exchange of data between two or more electronic devices. The skilled artisan will further appreciate that the computer network 102 includes, for example and without limitation, a virtual local area network, a wide area network, a personal area network, a local area network, the Internet, an intranet, or any suitable combination thereof. In accordance with the preferred embodiment of the subject application, the computer network 102 is comprised of physical layers and transport layers, as illustrated by the myriad of conventional data transport mechanisms, such as, for example and without limitation, Token-Ring, 802.11(x), Ethernet, or other wireless or wire-based data communication mechanisms. The skilled artisan will appreciate that while a computer network 102 is shown in FIG. 1, the subject application is equally capable of use in a stand-alone system, as will be known in the art.

The system 100 also includes a document processing device 104, which is depicted in FIG. 1 as a multifunction peripheral device, suitably adapted to perform a variety of document processing operations. It will be appreciated by those skilled in the art that such document processing operations include, for example and without limitation, facsimile, scanning, copying, printing, electronic mail, document management, document storage, or the like. Suitable commercially available document processing devices include, for example and without limitation, the Toshiba e-Studio Series Controller. In accordance with one aspect of the subject application, the document processing device 104 is suitably adapted to provide remote document processing services to external or network devices. Preferably, the document processing device 104 includes hardware, software, and any suitable combination thereof, configured to interact with an associated user, a networked device, or the like.

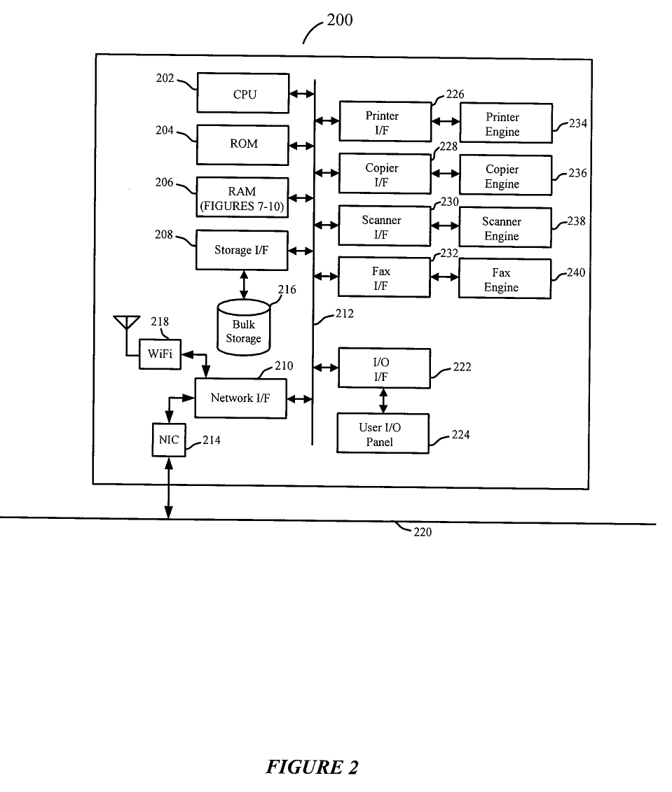

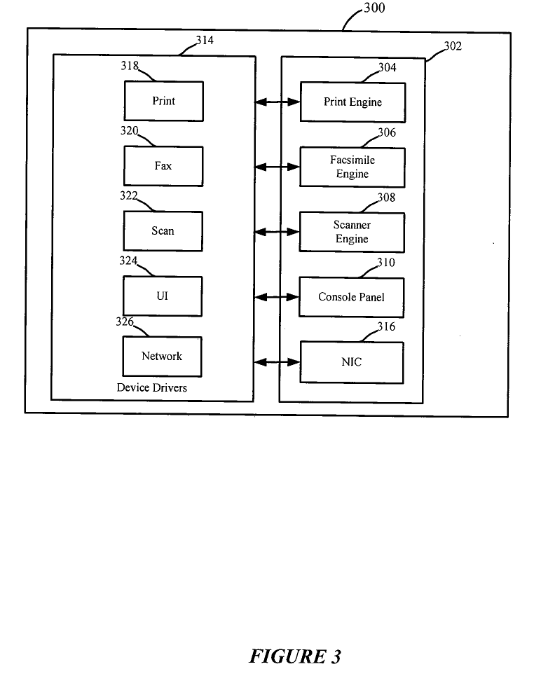

According to one embodiment of the subject application, the document processing device 104 is suitably equipped to receive a plurality of portable storage media, including, without limitation, Firewire drive, USB drive, SD, MMC, XD, Compact Flash, Memory Stick, and the like. In the preferred embodiment of the subject application, the document processing device 104 further includes an associated user interface 106, such as a touchscreen, LCD display, touch-panel, alpha-numeric keypad, or the like, via which an associated user is able to interact directly with the document processing device 104. In accordance with the preferred embodiment of the subject application, the user interface 106 is advantageously used to communicate information to the associated user and receive selections from the associated user. The skilled artisan will appreciate that the user interface 106 comprises various components, suitably adapted to present data to the associated user, as are known in the art. In accordance with one embodiment of the subject application, the user interface 106 comprises a display, suitably adapted to display one or more graphical elements, text data, images, or the like, to an associated user, receive input from the associated user, and communicate the same to a backend component, such as the controller 108, as explained in greater detail below. Preferably, the document processing device 104 is communicatively coupled to the computer network 102 via a communications link 112. As will be understood by those skilled in the art, suitable communications links include, for example and without limitation, WiMax, 802.11a, 802.11b, 802.11g, 802.11(x), Bluetooth, the public switched telephone network, a proprietary communications network, infrared, optical, or any other suitable wired or wireless data transmission communications known in the art. The functioning of the document processing device 104 will be better understood in conjunction with the block diagrams illustrated in FIGS. 2 and 3, explained in greater detail below.

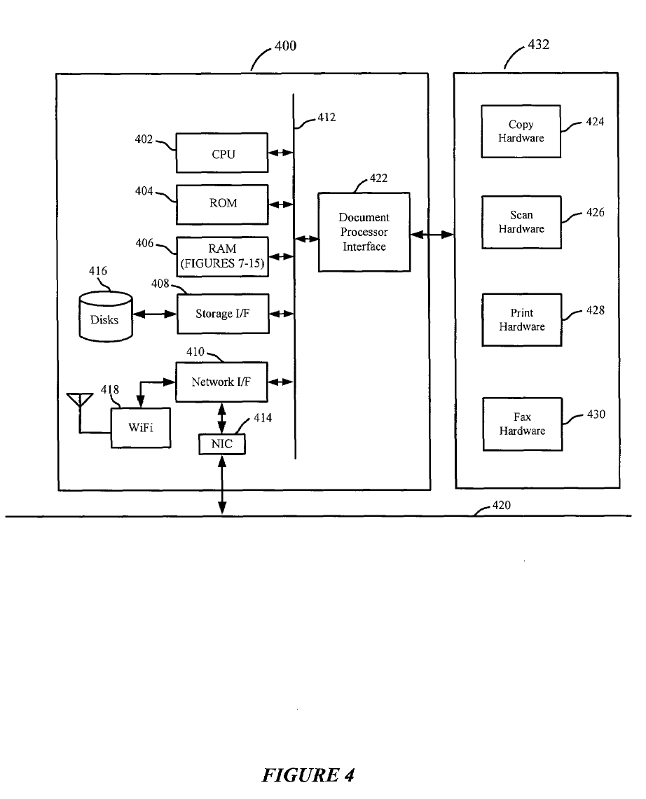

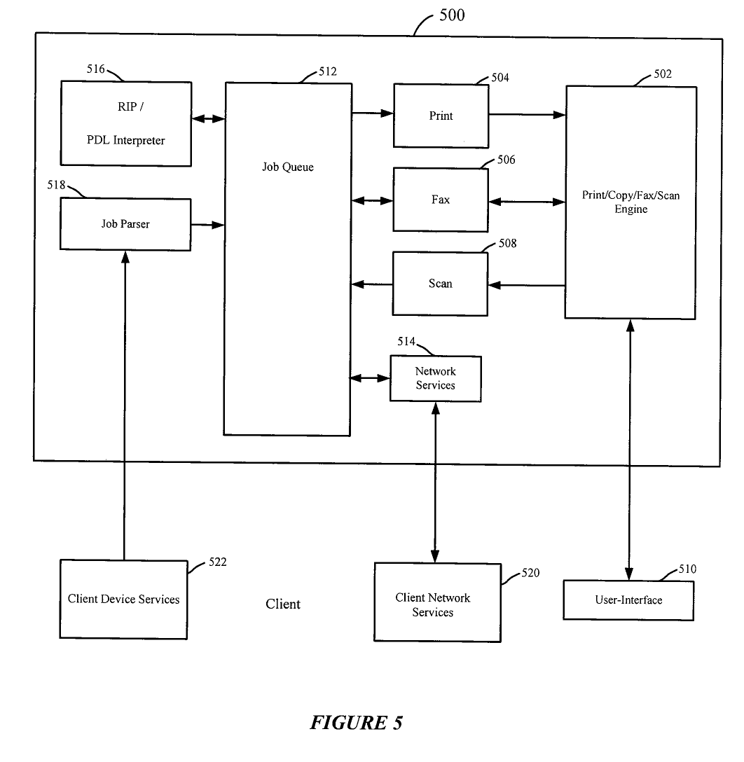

In accordance with one embodiment of the subject application, the document processing device 104 incorporates a backend component, designated as the controller 108, suitably adapted to facilitate the operations of the document processing device 104, as will be understood by those skilled in the art. Preferably, the controller 108 is embodied as hardware, software, or any suitable combination thereof, configured to control the operations of the associated document processing device 104, facilitate the display of images via the user interface 106, direct the manipulation of electronic image data, and the like. For purposes of explanation, the controller 108 is used to refer to any myriad of components associated with the document processing device 104, including hardware, software, or combinations thereof, functioning to perform, cause to be performed, control, or otherwise direct the methodologies described hereinafter. It will be understood by those skilled in the art that the methodologies described with respect to the controller 108 is capable of being performed by any general purpose computing system, known in the art, and thus the controller 108 is representative of such general computing devices and is intended as such when used hereinafter. Furthermore, the use of the controller 108 hereinafter is for the example embodiment only, and other embodiments, which will be apparent to one skilled in the art, are capable of employing the system and method for secure logging of document processing device messages. The functioning of the controller 108 will better be understood in conjunction with the block diagrams illustrated in FIGS. 4 and 5, explained in greater detail below.

Communicatively coupled to the document processing device 104 is a data storage device 110. In accordance with the one embodiment of the subject application, the data storage device 110 is any mass storage device known in the art including, for example and without limitation, magnetic storage drives, a hard disk drive, optical storage devices, flash memory devices, or any suitable combination thereof. In one embodiment, the data storage device 110 is suitably adapted to store scanned image data, modified image data, redacted data, user information, cellular telephone data, pre-set payment data, document data, image data, electronic database data, or the like. It will be appreciated by those skilled in the art that while illustrated in FIG. 1 as being a separate component of the system 100, the data storage device 110 is capable of being implemented as an internal storage component of the document processing device 104, a component of the controller 108, or the like, such as, for example and without limitation, an internal hard disk drive, or the like. In accordance with one embodiment of the subject application, the data storage device 110 is capable of storing document processing instructions, usage data, user interface data, job control data, controller status data, component execution data, images, advertisements, user information, location information, output templates, mapping data, multimedia data files, fonts, and the like.

FIG. 1 also illustrates a kiosk 114 communicatively coupled to the document processing device 104, and in effect, the computer network 102. It will be appreciated by those skilled in the art that the kiosk 114 is capable of being implemented as a separate component of the document processing device 104, or as an integral component thereof. Use of the kiosk 114 in FIG. 1 is for example purposes only, and the skilled artisan will appreciate that the subject application is capable of implementation without the use of the kiosk 114. In accordance with one embodiment of the subject application, the kiosk 114 includes an associated display 116, and a user input device 118. As will be understood by those skilled in the art the kiosk 114 is capable of implementing a combination user input device/display, such as a touchscreen interface. According to one embodiment of the subject application, the kiosk 114 is suitably adapted to display prompts to an associated user, receive document processing instructions from the associated user, receive payment data, receive selection data from the associated user, and the like. Preferably, the kiosk 114 includes a magnetic card reader, conventional bar code reader, or the like, suitably adapted to receive and read payment data from a credit card, coupon, debit card, or the like.

The system 100 of FIG. 1 also includes a portable storage device reader 120, coupled to the kiosk 114, which is suitably adapted to receive and access a myriad of different portable storage devices. Examples of such portable storage devices include, for example and without limitation, flash-based memory such as SD, xD, Memory Stick, compact flash, CD-ROM, DVD-ROM, USB flash drives, or other magnetic or optical storage devices, as will be known in the art.

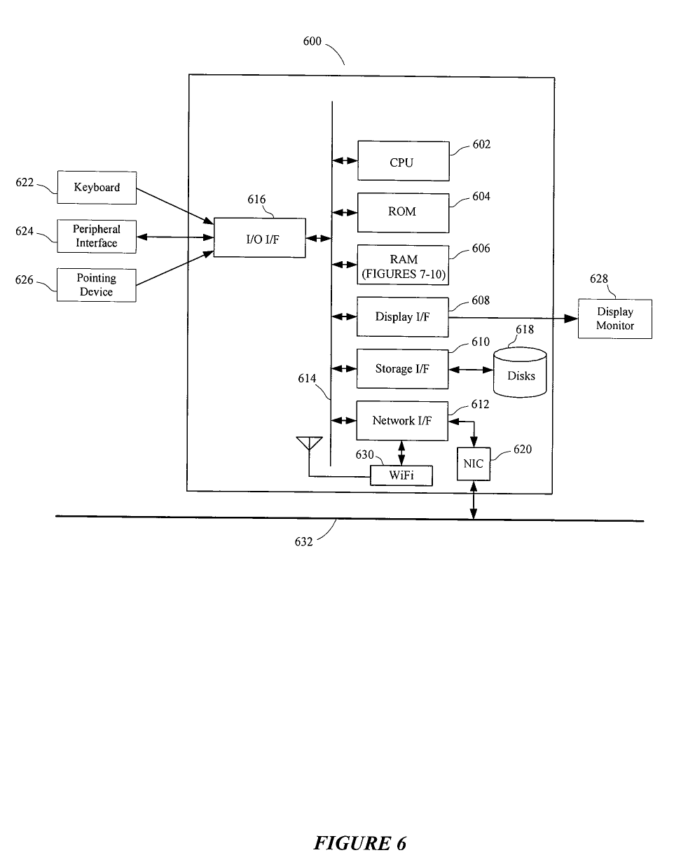

Depicted in FIG. 1 is an administrative device 122, illustrated as a personal computer in data communication with the computer network 102 via a communications link 124. It will be appreciated by those skilled in the art that the administrative device 122 is shown in FIG. 1 as a computer workstation for illustration purposes only. As will be understood by those skilled in the art, the administrative device 122 is representative of any personal computing device known in the art including, for example and without limitation, a laptop computer, a workstation computer, a personal data assistant, a web-enabled cellular telephone, a smart phone, a proprietary network device, or other web-enabled electronic device. The communications link 124 is any suitable channel of data communications known in the art including, but not limited to wireless communications, for example and without limitation, Bluetooth, WiMax, 802.11a, 802.11b, 802.11g, 802.11(x), a proprietary communications network, infrared, optical, the public switched telephone network, or any suitable wireless data transmission system, or wired communications known in the art. In accordance with one embodiment of the subject application, the administrative device 122 is suitably configured to facilitate the receipt and storage of secured logs from the document processing device 104, so as to function as an archive of secure device status logs. According to a further embodiment of the subject application, the administrative device 122 is implemented as a suitable networked storage device, as will be understood by those skilled in the art. Further, in accordance with one embodiment of the subject application, the administrative device 122 is capable of receiving documents, status data, job data, user interface data, image data, monitor document processing jobs, employ thin-client interfaces, generate display data, generate output data, or the like, with respect to the document processing device 104, or any other similar device coupled to the computer network 102. The functioning of the administrative device 122 will better be understood in conjunction with the diagram illustrated in FIG. 6, explained in greater detail below.

Turning now to FIG. 2, illustrated is a representative architecture of a suitable device 200, shown in FIG. 1 as the document processing device 104, on which operations of the subject system are completed. Included is a processor 202, suitably comprised of a central processor unit. However, it will be appreciated that the processor 202 may advantageously be composed of multiple processors working in concert with one another as will be appreciated by one of ordinary skill in the art. Also included is a non-volatile or read only memory 204 which is advantageously used for static or fixed data or instructions, such as BIOS functions, system functions, system configuration data, and other routines or data used for operation of the device 200. Also included in the device 200 is random access memory 206, suitably formed of dynamic random access memory, static random access memory, or any other suitable, addressable memory system. Random access memory provides a storage area for data instructions associated with applications and data handling accomplished by the processor 202.

A storage interface 208 suitably provides a mechanism for volatile, bulk or long term storage of data associated with the device 200. The storage interface 208 suitably uses bulk storage, such as any suitable addressable or serial storage, such as a disk, optical, tape drive and the like as shown as 216, as well as any suitable storage medium as will be appreciated by one of ordinary skill in the art.

A network interface subsystem 210 suitably routes input and output from an associated network allowing the device 200 to communicate to other devices. The network interface subsystem 210 suitably interfaces with one or more connections with external devices to the device 200. By way of example, illustrated is at least one network interface card 214 for data communication with fixed or wired networks, such as Ethernet, token ring, and the like, and a wireless interface 218, suitably adapted for wireless communication via means such as WiFi, WiMax, wireless modem, cellular network, or any suitable wireless communication system. It is to be appreciated however, that the network interface subsystem suitably utilizes any physical or non-physical data transfer layer or protocol layer as will be appreciated by one of ordinary skill in the art. In the illustration, the network interface card 214 is interconnected for data interchange via a physical network 220, suitably comprised of a local area network, wide area network, or a combination thereof.

Data communication between the processor 202, read only memory 204, random access memory 206, storage interface 208 and the network subsystem 210 is suitably accomplished via a bus data transfer mechanism, such as illustrated by the bus 212.

Suitable executable instructions on the device 200 facilitate communication with a plurality of external devices, such as workstations, document processing devices, other servers, or the like. While, in operation, a typical device operates autonomously, it is to be appreciated that direct control by a local user is sometimes desirable, and is suitably accomplished via an optional input/output interface 222 to a user input/output panel 224 as will be appreciated by one of ordinary skill in the art.

Also in data communication with the bus 212 are interfaces to one or more document processing engines. In the illustrated embodiment, printer interface 226, copier interface 228, scanner interface 230, and facsimile interface 232 facilitate communication with printer engine 234, copier engine 236, scanner engine 238, and facsimile engine 240, respectively. It is to be appreciated that the device 200 suitably accomplishes one or more document processing functions. Systems accomplishing more than one document processing operation are commonly referred to as multifunction peripherals or multifunction devices.

Turning now to FIG. 3, illustrated is a suitable document processing device, depicted in FIG. 1 as the document processing device 104, for use in connection with the disclosed system. FIG. 3 illustrates suitable functionality of the hardware of FIG. 2 in connection with software and operating system functionality as will be appreciated by one of ordinary skill in the art. The document processing device 300 suitably includes an engine 302 which facilitates one or more document processing operations.

The document processing engine 302 suitably includes a print engine 304, facsimile engine 306, scanner engine 308 and console panel 310. The print engine 304 allows for output of physical documents representative of an electronic document communicated to the processing device 300. The facsimile engine 306 suitably communicates to or from external facsimile devices via a device, such as a fax modem.

The scanner engine 308 suitably functions to receive hard copy documents and in turn image data corresponding thereto. A suitable user interface, such as the console panel 310, suitably allows for input of instructions and display of information to an associated user. It will be appreciated that the scanner engine 308 is suitably used in connection with input of tangible documents into electronic form in bitmapped, vector, or page description language format, and is also suitably configured for optical character recognition. Tangible document scanning also suitably functions to facilitate facsimile output thereof.

In the illustration of FIG. 3, the document processing engine also comprises an interface 316 with a network via driver 326, suitably comprised of a network interface card. It will be appreciated that a network thoroughly accomplishes that interchange via any suitable physical and non-physical layer, such as wired, wireless, or optical data communication.

The document processing engine 302 is suitably in data communication with one or more device drivers 314, which device drivers allow for data interchange from the document processing engine 302 to one or more physical devices to accomplish the actual document processing operations. Such document processing operations include one or more of printing via driver 318, facsimile communication via driver 320, scanning via driver 322 and a user interface functions via driver 324. It will be appreciated that these various devices are integrated with one or more corresponding engines associated with the document processing engine 302. It is to be appreciated that any set or subset of document processing operations are contemplated herein. Document processors which include a plurality of available document processing options are referred to as multi-function peripherals.

Turning now to FIG. 4, illustrated is a representative architecture of a suitable backend component, i.e., the controller 400, shown in FIG. 1 as the controller 108, on which operations of the subject system 100 are completed. The skilled artisan will understand that the controller 400 is representative of any general computing device, known in the art, capable of facilitating the methodologies described herein. Included is a processor 402, suitably comprised of a central processor unit. However, it will be appreciated that processor 402 may advantageously be composed of multiple processors working in concert with one another as will be appreciated by one of ordinary skill in the art. Also included is a non-volatile or read only memory 404 which is advantageously used for static or fixed data or instructions, such as BIOS functions, system functions, system configuration data, and other routines or data used for operation of the controller 400.

Also included in the controller 400 is random access memory 406, suitably formed of dynamic random access memory, static random access memory, or any other suitable, addressable and writable memory system. Random access memory provides a storage area for data instructions associated with applications and data handling accomplished by processor 402.

A storage interface 408 suitably provides a mechanism for non-volatile, bulk or long term storage of data associated with the controller 400. The storage interface 408 suitably uses bulk storage, such as any suitable addressable or serial storage, such as a disk, optical, tape drive and the like as shown as 416, as well as any suitable storage medium as will be appreciated by one of ordinary skill in the art.

A network interface subsystem 410 suitably routes input and output from an associated network allowing the controller 400 to communicate to other devices. The network interface subsystem 410 suitably interfaces with one or more connections with external devices to the device 400. By way of example, illustrated is at least one network interface card 414 for data communication with fixed or wired networks, such as Ethernet, token ring, and the like, and a wireless interface 418, suitably adapted for wireless communication via means such as WiFi, WiMax, wireless modem, cellular network, or any suitable wireless communication system. It is to be appreciated however, that the network interface subsystem suitably utilizes any physical or non-physical data transfer layer or protocol layer as will be appreciated by one of ordinary skill in the art. In the illustration, the network interface 414 is interconnected for data interchange via a physical network 420, suitably comprised of a local area network, wide area network, or a combination thereof.

Data communication between the processor 402, read only memory 404, random access memory 406, storage interface 408 and the network interface subsystem 410 is suitably accomplished via a bus data transfer mechanism, such as illustrated by bus 412.

Also in data communication with the bus 412 is a document processor interface 422. The document processor interface 422 suitably provides connection with hardware 432 to perform one or more document processing operations. Such operations include copying accomplished via copy hardware 424, scanning accomplished via scan hardware 426, printing accomplished via print hardware 428, and facsimile communication accomplished via facsimile hardware 430. It is to be appreciated that the controller 400 suitably operates any or all of the aforementioned document processing operations. Systems accomplishing more than one document processing operation are commonly referred to as multifunction peripherals or multifunction devices.

Functionality of the subject system 100 is accomplished on a suitable document processing device, such as the document processing device 104, which includes the controller 400 of FIG. 4, (shown in FIG. 1 as the controller 108) as an intelligent subsystem associated with a document processing device. In the illustration of FIG. 5, controller function 500 in the preferred embodiment includes a document processing engine 502. Suitable controller functionality is that incorporated into the Toshiba e-Studio system in the preferred embodiment. FIG. 5 illustrates suitable functionality of the hardware of FIG. 4 in connection with software and operating system functionality as will be appreciated by one of ordinary skill in the art.

In the preferred embodiment, the engine 502 allows for printing operations, copy operations, facsimile operations and scanning operations. This functionality is frequently associated with multi-function peripherals, which have become a document processing peripheral of choice in the industry. It will be appreciated, however, that the subject controller does not have to have all such capabilities. Controllers are also advantageously employed in dedicated or more limited purposes document processing devices that perform one or more of the document processing operations listed above.

The engine 502 is suitably interfaced to a user interface panel 510, which panel allows for a user or administrator to access functionality controlled by the engine 502. Access is suitably enabled via an interface local to the controller, or remotely via a remote thin or thick client.

The engine 502 is in data communication with the print function 504, facsimile function 506, and scan function 508. These functions facilitate the actual operation of printing, facsimile transmission and reception, and document scanning for use in securing document images for copying or generating electronic versions.

A job queue 512 is suitably in data communication with the print function 504, facsimile function 506, and scan function 508. It will be appreciated that various image forms, such as bit map, page description language or vector format, and the like, are suitably relayed from the scan function 308 for subsequent handling via the job queue 512.

The job queue 512 is also in data communication with network services 514. In a preferred embodiment, job control, status data, or electronic document data is exchanged between the job queue 512 and the network services 514. Thus, suitable interface is provided for network based access to the controller function 500 via client side network services 520, which is any suitable thin or thick client. In the preferred embodiment, the web services access is suitably accomplished via a hypertext transfer protocol, file transfer protocol, uniform data diagram protocol, or any other suitable exchange mechanism. The network services 514 also advantageously supplies data interchange with client side services 520 for communication via FTP, electronic mail, TELNET, or the like. Thus, the controller function 500 facilitates output or receipt of electronic document and user information via various network access mechanisms.

The job queue 512 is also advantageously placed in data communication with an image processor 516. The image processor 516 is suitably a raster image process, page description language interpreter or any suitable mechanism for interchange of an electronic document to a format better suited for interchange with device functions such as print 504, facsimile 506 or scan 508.

Finally, the job queue 512 is in data communication with a parser 518, which parser suitably functions to receive print job language files from an external device, such as client device services 522. The client device services 522 suitably include printing, facsimile transmission, or other suitable input of an electronic document for which handling by the controller function 500 is advantageous. The parser 518 functions to interpret a received electronic document file and relay it to the job queue 512 for handling in connection with the afore-described functionality and components.

Turning now to FIG. 6, illustrated is a hardware diagram of a suitable workstation 600, shown as the administrative device 122, for use in connection with the subject system. A suitable workstation includes a processor unit 602 which is advantageously placed in data communication with read only memory 604, suitably non-volatile read only memory, volatile read only memory or a combination thereof, random access memory 606, display interface 608, storage interface 610, and network interface 612. In a preferred embodiment, interface to the foregoing modules is suitably accomplished via a bus 614.

The read only memory 604 suitably includes firmware, such as static data or fixed instructions, such as BIOS, system functions, configuration data, and other routines used for operation of the workstation 600 via CPU 602.

The random access memory 606 provides a storage area for data and instructions associated with applications and data handling accomplished by the processor 602.

The display interface 608 receives data or instructions from other components on the bus 614, which data is specific to generating a display to facilitate a user interface. The display interface 608 suitably provides output to a display terminal 628, suitably a video display device such as a monitor, LCD, plasma, or any other suitable visual output device as will be appreciated by one of ordinary skill in the art.

The storage interface 610 suitably provides a mechanism for non-volatile, bulk or long term storage of data or instructions in the workstation 600. The storage interface 610 suitably uses a storage mechanism, such as storage 618, suitably comprised of a disk, tape, CD, DVD, or other relatively higher capacity addressable or serial storage medium.

The network interface 612 suitably communicates to at least one other network interface, shown as network interface 620, such as a network interface card, and wireless network interface 630, such as a WiFi wireless network card. It will be appreciated that by one of ordinary skill in the art that a suitable network interface is comprised of both physical and protocol layers and is suitably any wired system, such as Ethernet, token ring, or any other wide area or local area network communication system, or wireless system, such as WiFi, WiMax, or any other suitable wireless network system, as will be appreciated by one of ordinary skill in the art. In the illustration, the network interface 620 is interconnected for data interchange via a physical network 632, suitably comprised of a local area network, wide area network, or a combination thereof.

An input/output interface 616 in data communication with the bus 614 is suitably connected with an input device 622, such as a keyboard or the like. The input/output interface 616 also suitably provides data output to a peripheral interface 624, such as a USB, universal serial bus output, SCSI, Firewire (IEEE 1394) output, or any other interface as may be appropriate for a selected application. Finally, the input/output interface 616 is suitably in data communication with a pointing device interface 626 for connection with devices, such as a mouse, light pen, touch screen, or the like.

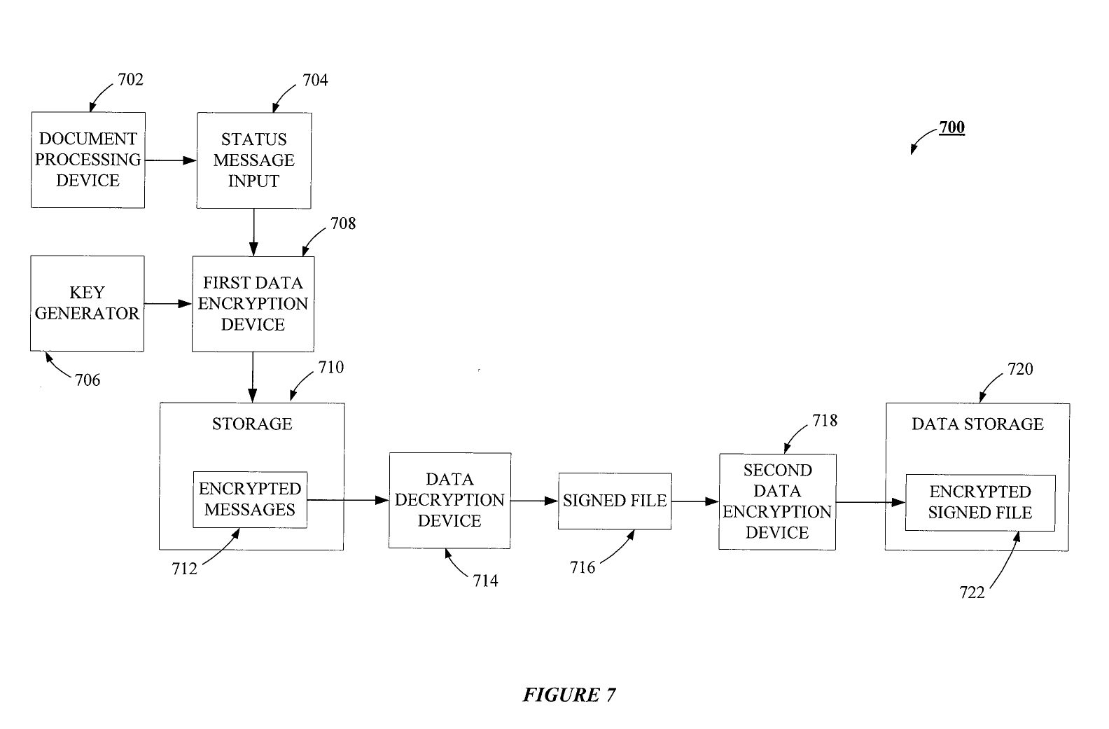

Turning now to FIG. 7, illustrated is a block diagram of a system 700 for secure logging of document processing device messages in accordance with one embodiment of the subject application. The system 700 includes a status message input 704 in data communication with a document processing device 702 from which status messages are received over a predefined temporal duration. The system 700 further includes a key generator 706 configured to generate encryption keys, as will be appreciated by those skilled in the art. In data communication with the key generator 706 and the input 704 is a first data encryption device 708 that is operable on each of the status messages as they arrive in connection with a key generated by the key generator 706.

The system 700 also includes a storage 710 that stores each of the encrypted messages 712 output by the first encryption device 708. The system 700 further employs a data decryption device 714 operable on each of the plurality of encrypted messages so as to decrypt the encrypted messages following the completion of the predefined temporal duration and output a signed file 716, which consists of each of the decrypted messages. It will be appreciated by those skilled in the art that the signing of the signed file 716 is capable of being performed by the document processing device 702, a component associated therewith, a separate component of the system 700, or a suitable combination thereof. The system further employs a second data encryption device 718 operable on the signed file 716 so as to encrypt the signed file in accordance with the key generated by the key generator 706. In addition, the system employs a data storage 720 that is configured to store the encrypted signed file 722 associatively with the key generated by the key generator 706.

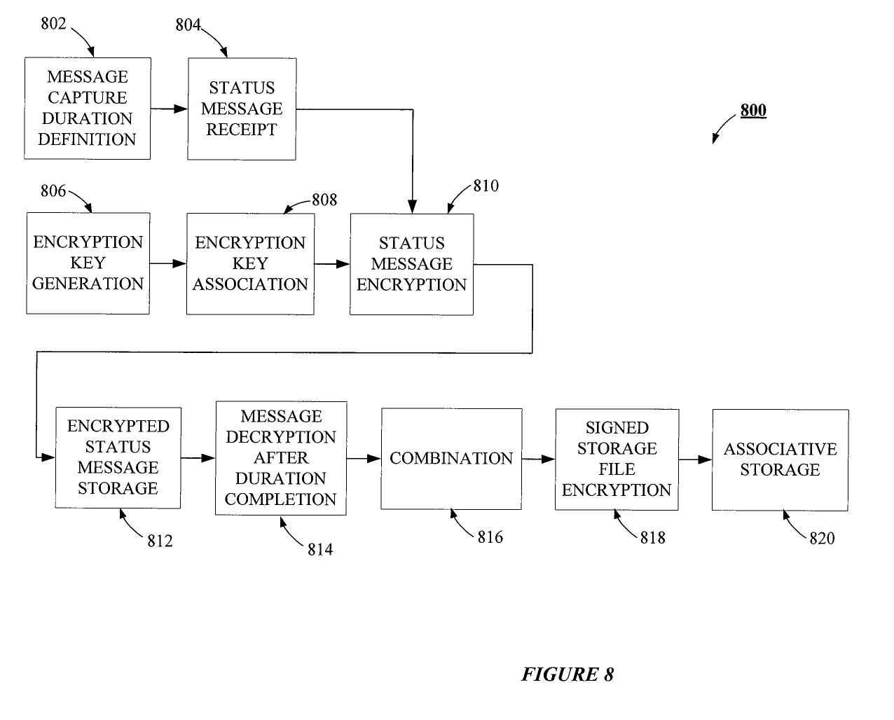

Referring now to FIG. 8, there is shown a functional diagram illustrating the system 800 for secure logging of document processing device messages in accordance with one embodiment of the subject application. A message capture duration definition 802 is first determined in accordance with a preselected period of time, e.g. a day, number of hours, number of days, etc. Document processing device status message receipt 804 then occurs corresponding to the receipt of unencrypted document processing status messages in accordance with the definition 802. Encryption key generation 806 is then performed corresponding to the generation of an encryption key associated with the message capture duration definition 802. Encryption key association 808 is then performed so as to associate the encryption key with the duration definition 802. Status message encryption 810 is then performed on the status messages as each message is received. Encrypted status message storage 812 then occurs following the encryption of the status message at 810.

Status message decryption 814 is then performed so as to decrypt each of the encrypted document processing status messages in accordance with the key resulting from the encryption key generation 806 following completion of the duration definition 802. A combination 816 is then made of each decrypted message into a single, signed storage file. Signed storage file encryption 818 then occurs so as to encrypt the signed storage file in accordance with the generated key. Associative storage 820 is then performed so as to associatively store the encrypted signed storage file with the generated encryption key.

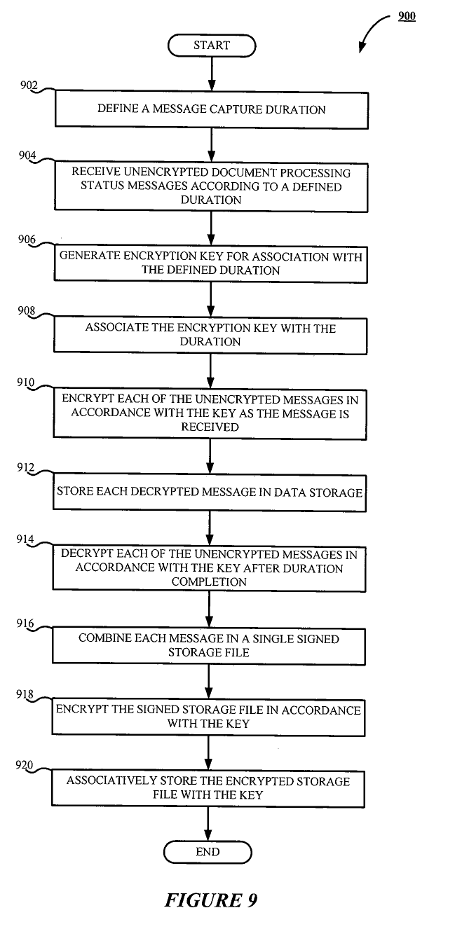

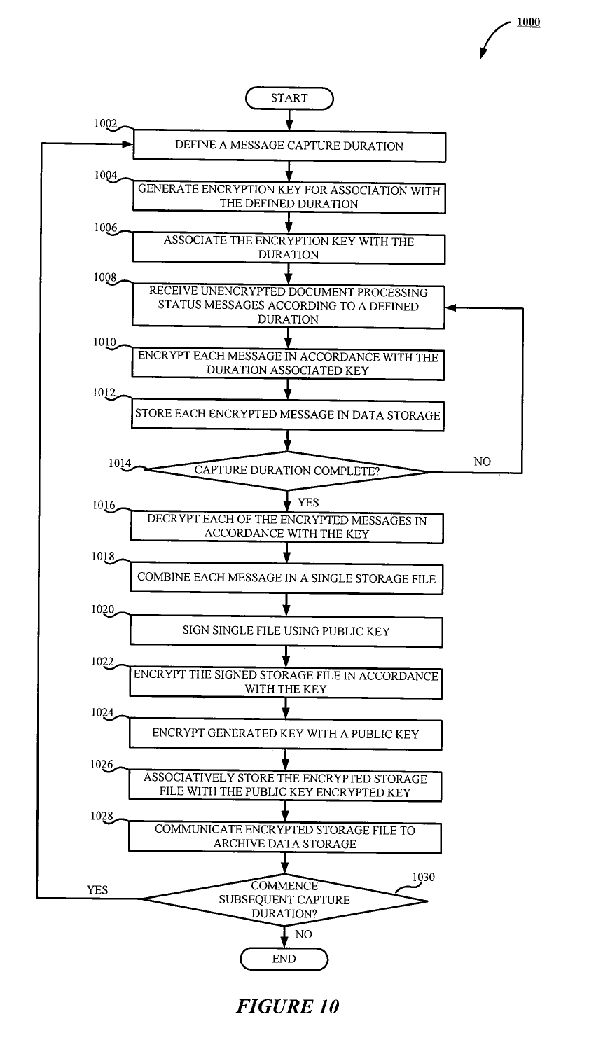

The skilled artisan will appreciate that the subject system 100 and components described above with respect to FIG. 1, FIG. 2, FIG. 3, FIG. 4, FIG. 5, FIG. 6, FIG. 7, and FIG. 8 will be better understood in conjunction with the methodologies described hereinafter with respect to FIG. 9 and FIG. 10. Turning now to FIG. 9, there is shown a flowchart 900 illustrating a method for secure logging of document processing device messages in accordance with one embodiment of the subject application. Beginning at step 902, a message capture duration is defined by the administrative device 122, an administrator associated with the document processing device 104, or the like. In accordance with one embodiment of the subject application, the message capture duration corresponds to a preselected period of time during which the document processing device 104 is operative. According to one embodiment of the subject application, the duration is representative of an amount of time (hours, days, weeks, months), a preselected number of operations, or the like.

At step 904, the controller 108, the administrative device 122, or other suitable monitoring component in data communication with the document processing device 104 receives a plurality of unencrypted document processing status messages in accordance with a defined duration. The skilled artisan will appreciate that such messages include, for example and without limitation, document processing device logging data, resource usage data, processing data, and the like. The controller 108 or other suitable component associated with the document processing device 104, the administrative device 122, or the like, then generates an encryption key for association with the defined duration at step 906. At step 908, the encryption key is associated with the defined duration via the controller 108 or other suitable component associated with the document processing device 104, administrative device 122, or the like.

At step 910, each of the unencrypted document processing status messages is encrypted in accordance with the key as the message is received. That is, upon receipt of a document processing status message, the controller 108 or other suitable component associated with the document processing device 104, encrypts that received message using the generated key. The skilled artisan will appreciate that the controller 108 or other suitable component associated with the document processing device 104, the administrative device 122, or other suitable device is capable of performing the encryption of the messages in accordance with the generated encryption key. At step 912, each encrypted status message is stored in an associated data storage, e.g. the data storage device 110 associated with the document processing device 104, a data storage device associated with the administrative device 122, or the like.

At step 914, the controller 108 or other suitable component associated with the document processing device 104 decrypts each of the stored encrypted status messages following the completion of the defined duration. The controller 108 or other suitable component associated with the document processing device 104, or the like, then combines each of the decrypted messages into a single, signed storage file at step 916. In accordance with one embodiment of the subject application, the signing of the single stored file is accomplished via a public key associated with the document processing device 104, as will be understood by those skilled in the art. At step 918, the controller 108 or other suitable component associated with the document processing device 104 encrypts the signed storage file in accordance with the key. Thereafter, at step 920, the encrypted storage file is associatively stored with the key.

Referring now to FIG. 10, there is shown a flowchart 1000 illustrating a method for secure logging of document processing device messages in accordance with one embodiment of the subject application. The methodology of FIG. 10 begins at step 1002, whereupon an administrator, such as a user associated with the administrative device 122, defines a status message capture duration for messages, e.g. operations logs, generated by the document processing device 104. It will be understood by those skilled in the art that the defined duration is capable of including, for example and without limitation, a period of time (minutes, hours, days, weeks, months, etc.), a set number of document processing operations, or the like. At step 1004, the controller 108 or other suitable component associated with the document processing device 104, or the administrative device 122, generates an encryption key for association with the defined duration. In accordance with one embodiment of the subject application, the encryption key generated for association with the defined duration is a single symmetric key, as will be understood by those skilled in the art.

At step 1006, the controller 108 or other suitable component associated with the document processing device 104 associates the generated encryption key with the defined duration. Unencrypted document processing device status messages are then received from the document processing device 104 by the controller 108 or other suitable component associated therewith at step 1008. In accordance with one embodiment of the subject application, the status messages include, for example and without limitation, resource usage data, output media data, storage data, processing data, error data, correction data, and the like.

Each of the device status messages are then encrypted at step 1010 in accordance with the encryption key that has been associated with the defined duration during which the message was received. It will be appreciated by those skilled in the art that the controller 108 or other suitable component associated with the document processing device 104 is capable of encrypting each individual message using the symmetric encryption key. At step 1012, each separately encrypted message is stored in an associated data storage, e.g. the data storage device 110 associated with the document processing device 104. The skilled artisan will appreciate that such storage of messages is capable of being accomplished via a suitable database, wherein each message corresponds to a tabular entry, or the like. At step 1014, a determination is made by the controller 108 or other suitable component associated with the document processing device 104 whether the defined duration has expired. That is, the controller 108 determines whether the preselected period of time, i.e. duration, has lapsed. In the event that the defined capture duration is not complete, flow returns to receiving unencrypted status messages at step 1008, as set forth in greater detail above.

Upon a determination at step 1014 that the defined capture duration has been completed, e.g. end of the work day, end of the day, end of the week, end of the month, or the like, flow progresses to step 1016. At step 1016, the controller 108 or other suitable component associated with the document processing device 104 decrypts each of the encrypted status messages in accordance with the generated key. Stated another way, each entry in the database corresponding to the defined capture duration is decrypted using the encryption key associated with the defined duration. Each of the decrypted status messages are then combined into a single file by the controller 108 or other suitable component associated with the document processing device 104 at step 1018. At step 1020, the controller 108 or other suitable component associated with the document processing device 104 digitally signs the single file using the public encryption key associated with the document processing device 104 so as to generate a single signed storage file corresponding to the status messages. In accordance with one embodiment of the subject application, the public key used to sign the single storage file is an asymmetric encryption key, as will be understood by those skilled in the art.

The signed single storage file is then encrypted in accordance with the encryption key associated with the defined duration at step 1022. At step 1024, the encryption key associated with the defined duration is encrypted using the public key associated with the document processing device 104 by the controller 108 or other suitable component associated with the document processing device 104. The encrypted storage file is then associatively stored with the public key encrypted key at step 1026 in the data storage device 110 or other suitable component associated with the document processing device 104. At step 1028, the encrypted storage file and associated public key encrypted key are communicated to an archive data storage. In accordance with one embodiment of the subject application, the encrypted archive files are communicated via the computer network 102 to the administrative device 122, a network storage (not shown), or the like, so as to have an accessible, secure archive of status messages associated with the document processing device 104. At step 1030, a determination is made by the controller 108 or other suitable component associated with the document processing device 104 whether a subsequent capture duration is to be commenced. That is, whether another capture duration is to be defined for which messages are to be gathered and archived. Upon a positive determination at step 1030, flow returns to step 1002, whereupon the administrator defines a subsequent capture duration for message acquisition. Operations then continue in accordance with the methodology described above with respect to FIG. 10. Upon a negative determination at step 1030, the methodology of FIG. 10 terminates.

The foregoing description of a preferred embodiment of the subject application has been presented for purposes of illustration and description. It is not intended to be exhaustive or to limit the subject application to the precise form disclosed. Obvious modifications or variations are possible in light of the above teachings. The embodiment was chosen and described to provide the best illustration of the principles of the subject application and its practical application to thereby enable one of ordinary skill in the art to use the subject application in various embodiments and with various modifications as are suited to the particular use contemplated. All such modifications and variations are within the scope of the subject application as determined by the appended claims when interpreted in accordance with the breadth to which they are fairly, legally and equitably entitled.

What is claimed:

1. A system for secure logging of document processing device messages comprising:
an input operable to receive each of a plurality of status messages from an associated document processing device over a predefined temporal duration;
a key generator;
a first data encryption device operable on each of the plurality of status messages in connection with a generated key as each message is received via the input;
a storage adapted for storing each of a plurality of encrypted status messages;
a data decryption device operable on each of the plurality of encrypted status messages in connection with the generated key after the predefined temporal duration;
a second data encryption device operable on a signed file comprising each of a plurality of decrypted messages; and
a data storage for storing the encrypted signed file associatively with the key.

2. The system of claim 1 further comprising a key encryption device operable on the key prior to associatively storing thereof with the encrypted signed file.

3. The system of claim 2 further comprising a timer operable to define the temporal duration.

4. The system of claim 2 wherein the duration is set as daily.

5. The system of claim 4 further comprising an archiving system operable for storing the encrypted key and encrypted signed file from a previous day prior to commencement of a subsequent temporal duration.

6. A method for secure logging of document processing device messages comprising the steps of:
defining a message capture duration;
receiving a plurality of unencrypted document processing status messages in accordance with a defined duration;
generating an encryption key for association with the defined duration;
associating the encryption key with the defined duration;
encrypting each of the plurality of unencrypted document processing status messages in accordance with the key as each message is received;
storing, in an associated data storage, each encrypted status message;
decrypting each of the plurality of encrypted document processing status messages after a completion of the defined duration;
combining each decrypted message in a single, signed storage file;
encrypting the signed storage file in accordance with the key; and
associatively storing the encrypted storage file with the key.

7. The method of claim 6 further comprising the step of encrypting the key with a public key prior to storage thereof.

8. The method of claim 6 wherein the message capture duration is defined as one day.

9. The method of claim 7 wherein the step of associatively storing includes the step of communicating the encrypted storage file to an archive data storage, and wherein the method further includes the step of commencing a subsequent capture duration after completion of a previous capture duration.

10. A system for secure logging of document processing device messages comprising:
means adapted for defining a message capture duration;
means adapted for receiving a plurality of unencrypted document processing status messages in accordance with a defined duration;
means adapted for generating an encryption key for association with the defined duration;
means adapted for associating the encryption key with the defined duration;
means adapted for encrypting each of the plurality of unencrypted document processing status messages in accordance with the key as each message is received;
means adapted for storing, in an associated data storage, each encrypted status message;
means adapted for decrypting each of the encrypted status messages after a completion of the defined duration;
means adapted for combining each decrypted message in a single, signed storage file;
means adapted for encrypting the signed storage file in accordance with the key; and
means adapted for associatively storing the encrypted storage file with the key.

11. The system of claim 5 further comprising means adapted for encrypting the key with a public key prior to storage thereof.

12. The system of claim 11 wherein the message capture duration is defined as one day.

13. The method of claim 12 wherein the means adapted for associatively storing includes means adapted for communicating the encrypted storage file to an archive data storage, and wherein the system further includes means adapted for commencing a subsequent capture duration after completion of a previous capture duration.
